(19) United States
(12) Patent Application Publication
(10) Pub. No.: US 2026/0279693 A1
(43) Pub. Date: Sep. 17, 2026

(54) ELECTROCHEMICAL CAPACITOR

(71) Applicant: Panasonic Intellectual Property Management Co., Ltd., Osaka (JP)

(72) Inventors: Hiroshi KOBAYASHI, Kyoto Fu (JP); Nobuhiro SHIMAMURA, Osaka Fu (JP); Shingo NAGATA, Osaka Fu (JP)

(73) Assignee: Panasonic Intellectual Property Management Co., Ltd., Osaka (JP)

(21) Appl. No.: 19/168,754

(22) PCT Filed: Mar. 4, 2024
(86) PCT No.: PCT/JP2024/008136

§ 371 Date: Sep. 24, 2025

(30) Foreign Application Priority Data
Mar. 28, 2023 (JP) 2023-050796

(51) Int. Cl. H01G 11/50; H01G 11/06; H01G 11/26; H01G 11/32; H01G 11/62

(52) U.S. Cl. CPC H01G 11/50; H01G 11/06; H01G 11/26; H01G 11/32; H01G 11/62

(57) ABSTRACT

The disclosed electrochemical capacitor includes: a positive electrode including a positive electrode current collector, and a positive electrode mixture layer containing activated carbon, and supported on the positive electrode current collector; a negative electrode including a negative electrode current collector, and a negative electrode mixture layer containing a negative electrode active material into which lithium ions are reversibly doped, and supported on the negative electrode current collector; and an electrolyte solution including an electrolyte containing lithium ions and anions, and a nonaqueous solvent. The ratio of the amount of the anions to the surface area of the positive electrode mixture layer is 1.5 μmol/m² or more and 2.4 μmol/m² or less.

### CROSS REFERENCE TO RELATED APPLICATION

The present disclosure claims priority with respect to the Japanese Patent Application No. 2023-050796 filed on Mar. 28, 2023, and the entire content of the patent application is incorporated herein by reference into the present specification.

### TECHNICAL FIELD

The present invention relates to an electrochemical capacitor.

### BACKGROUND ART

Electrochemical capacitors that combine the power storage principle of lithium-ion secondary batteries and that of electric double layer capacitors have been attracting attention in recent years. In such electrochemical capacitors, usually, a polarizable electrode is used for the positive electrode, and a non-polarizable electrode is used for the negative electrode. As a result, the electrochemical capacitors are expected to have both high energy density of lithium-ion secondary batteries and high output characteristics of electric double layer capacitors.

Patent Literature 1 proposes a positive electrode for a lithium ion capacitor, characterized in that the pore volume of the pores having a pore diameter of 1.0 nm or more and less than 1.4 nm in the positive electrode layer calculated by the HK method is 0.11 cc/g or more, and the total pore volume calculated by the BET method is 1.1 cc/g or less.

Patent Literature 2 proposes a lithium ion capacitor, comprising a positive electrode, a negative electrode, and an electrolyte solution in contact with the positive electrode and the negative electrode, in which the electrolyte solution contains an organic solvent and a lithium salt electrolyte having an imide structure, and the organic solvent includes ethylene carbonate and propylene carbonate.

### CITATION LIST

### Patent Literature

Patent Literature 1: Japanese Patent No. 6422483
Patent Literature 2: Japanese Patent No. 7103376

### SUMMARY OF INVENTION

### Technical Problem

However, in the electrochemical capacitors as mentioned above, in order to achieve high output at a higher level, further improvements are required.

In an electrochemical capacitor, the internal resistance (DCR) tends to increase especially at low temperatures. Also, the internal resistance tends to increase when a float charge in which a constant voltage is applied to an electrochemical capacitor using an external DC power source is performed at a high temperature. To obtain high output characteristics, a reduction in the initial internal resistance and a reduction in the internal resistance after the float test are required.

### Solution to Problem

The present invention relates to an electrochemical capacitor, including: a positive electrode including a positive electrode current collector, and a positive electrode mixture layer containing activated carbon, and supported on the positive electrode current collector; a negative electrode including a negative electrode current collector, and a negative electrode mixture layer containing a negative electrode active material into which lithium ions are reversibly doped, and supported on the negative electrode current collector; and an electrolyte solution including an electrolyte containing lithium ions and anions, and a nonaqueous solvent, wherein a ratio of an amount of the anions to a surface area of the positive electrode mixture layer is 1.5 μmol/m² or more and 2.4 μmol/m² or less.

### Advantageous Effects of Invention

According to the present invention, it is possible to provide an electrochemical capacitor having low internal resistance and high output.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF DRAWING

FIG. 1 A longitudinal sectional view of an electrochemical capacitor according to one embodiment of the present invention.

### DESCRIPTION OF EMBODIMENTS

Embodiments of the present disclosure will be described below by way of examples, but the present disclosure is not limited to the examples described below. In the following description, specific numerical values and materials are exemplified in some cases, but other numerical values and other materials may be adopted as long as the effects of the present disclosure can be obtained. For the components other than those characteristic of the present disclosure, any known components may be adopted. In the present specification, when referring to “a range of a numerical value A to a numerical value B,” the range includes the numerical value A and the numerical value B.

In the following description, when the lower and upper limits of numerical values related to specific physical properties, conditions, etc. are mentioned as examples, any one of the mentioned lower limits and any one of the mentioned upper limits can be combined in any combination as long as the lower limit is not equal to or more than the upper limit. When a plurality of materials are mentioned as examples, unless otherwise specified, one kind of them may be selected and used singly, or two or more kinds of them may be used in combination.

The present disclosure encompasses a combination of matters recited in any two or more claims selected from plural claims in the appended claims. In other words, as long as no technical contradiction arises, matters recited in any two or more claims selected from plural claims in the appended claims can be combined.

An electrochemical capacitor according to an embodiment of the present invention includes a positive electrode, a negative electrode, and an electrolyte solution. In general, the positive electrode and the negative electrode, together with a separator interposed therebetween, constitute an electrode body. The electrode body is constituted, for example, as a columnar wound body formed by winding a belt-shaped positive electrode and a belt-shaped negative electrode with a separator interposed therebetween. The electrode body may be constituted as a stacked body formed by stacking a plate-shaped positive electrode and a plate-shaped negative electrode with a separator interposed therebetween.

The positive electrode includes, for example, a positive electrode current collector, and a positive electrode mixture layer containing activated carbon, and supported on the positive electrode current collector. The positive electrode mixture layer contains a positive electrode active material, such as activated carbon, into which anions are reversibly doped. When anions are adsorbed onto the positive electrode active material such as activated carbon, an electric double layer is formed, to exhibit capacity. The positive electrode may be a polarizable electrode, and may be an electrode which has the properties of a polarizable electrode and in which a Faradaic reaction also contributes to the capacity.

The doping of anions into the active material is a concept that includes at least an adsorption phenomenon of anions onto the positive electrode active material, and can include absorption of anions by the positive electrode active material such as activated carbon, and chemical interactions between the positive electrode active material such as activated carbon, and anions.

The negative electrode includes a negative electrode current collector, and a negative electrode mixture layer containing a negative electrode active material into which lithium ions are reversibly doped, and supported on the negative electrode current collector. In the negative electrode active material, a Faradaic reaction proceeds in which lithium ions are reversibly absorbed thereinto and released therefrom, through which capacity is exhibited. The doping of lithium ions into the negative electrode active material is a concept that includes at least an absorption phenomenon of lithium ions into the negative electrode active material, and may also include adsorption of lithium ions onto the negative electrode active material and chemical interactions between the negative electrode active material and lithium ions.

Hereinafter, the positive electrode and the negative electrode are sometimes collectively referred to as an electrode. The positive electrode current collector and the negative electrode current collector are sometimes collectively referred to as a current collector (or an electrode current collector). The positive electrode mixture layer and the negative electrode mixture layer are sometimes collectively referred to as a mixture layer (or an electrode mixture layer). The positive electrode active material and the negative electrode active material are sometimes collectively referred to as an active material (or an electrode active material).

The electrolyte solution contains an electrolyte containing lithium ions and anions, and a nonaqueous solvent. The electrolyte solution has lithium ion conductivity, and the anions are reversibly doped into and de-doped from the positive electrode. The lithium ions are reversibly absorbed into and released from the negative electrode.

A ratio of an amount of the anions to a surface area of the positive electrode mixture layer is 1.5 μmol/m² or more and 2.4 μmol/m² or less. This can suppress the initial internal resistance of the electrochemical capacitor to be low. In addition, since the deterioration of the positive electrode can be suppressed, the internal resistance can be kept low even after charge-discharge cycles repeated many times, and high output characteristics can be achieved.

The ratio of the amount of the anions to the surface area of the positive electrode mixture layer serves as an index showing a ratio of an amount of the anions which are reversibly doped and de-doping repeatedly at the surface of the positive electrode mixture layer, to the surface area of the positive electrode mixture layer. This ratio is expressed as an amount obtained by dividing the amount of the anions by the surface area of the positive electrode mixture layer.

The amount of the anions is expressed as a molar amount A of the anions contained per one cell of the electrochemical capacitor. The surface area of the positive electrode mixture layer is expressed as a surface area B of the positive electrode mixture layer per cell of the electrochemical capacitor, and is calculated from a specific surface area b of the positive electrode mixture layer.

The ratio of the amount of the anions to the surface area of the positive electrode mixture layer is expressed as a ratio A/B obtained by dividing the anion amount A by the surface area B of the positive electrode mixture layer.

Here, the deterioration of the positive electrode is evaluated typically by the increase rate of the low-temperature DCR of the electrochemical capacitor when a float charge in which a constant voltage is applied to an electrochemical capacitor using an external DC power source is performed at a high temperature. The increase rate of the low-temperature DCR is a ratio of the difference (ΔDCR) between the initial low-temperature DCR and the low-temperature DCR after the float charge, to the initial low-temperature DCR of the electrochemical capacitor. It can be said that the smaller the increase rate of the low-temperature DCR is, the smaller the deterioration of the positive electrode is.

When the ratio A/B of the anion amount to the surface area of the positive electrode mixture layer is small, since the anion amount A to be reversibly doped and de-doping repeatedly at the surface of the positive electrode mixture layer is small, sufficient capacity fails to be exhibited, and moreover, the initial internal resistance is also increased. On the other hand, when the A/B is large, the capacity increases, but the deterioration of the positive electrode tends to proceed. For example, the internal resistance after the float test tends to rise, increasing the difference between the internal resistances at the initial stage and after the float charge, and as a result, the internal resistance after the float charge becomes high. When the A/B is less than 1.5 μmol/m², the increase in the initial internal resistance is significant. When the A/B exceeds 2.4 μmol/m², the deterioration of the positive electrode proceeds rapidly, and the internal resistance after the float charge increases excessively. However, when the A/B is in the range of 1.5 to 2.4 μmol/m², a low initial internal resistance and a low internal resistance after the float charge can be both achieved, and the output characteristics can be maintained at a high level.

It is desirable that the ratio A/B of the anion amount to the surface area of the positive electrode mixture layer is 1.7 μmol/m² or more and 2.2 μmol/m² or less. In this case, the initial internal resistance and the internal resistance after the float charge are significantly reduced, and the output characteristics of the electrochemical capacitor can be further improved.

The anion amount A (mmol) contained per one cell of the electrochemical capacitor is expressed by the following equation using the molar concentration (M) of the electrolyte contained in the electrolyte, the mass (g) of the electrolyte solution, and the specific gravity (g/cm³) of the electrolyte solution.

Anion amount A=(molar concentration of electrolyte contained in electrolyte solution)×(mass of electrolyte solution)/(specific gravity of electrolyte solution)

The surface area B (m²) of the positive electrode mixture layer contained per one cell of the electrochemical capacitor is expressed by the following equation. It is calculated by multiplying the surface area per unit mass of the positive electrode mixture layer (specific surface area b of positive electrode mixture layer) (m²/g) by the mass of the positive electrode mixture layer (mass of positive electrode−mass of positive electrode current collector) (g).

Surface area B of positive electrode mixture layer=(specific surface area b of positive electrode mixture layer)×(mass of positive electrode−mass of positive electrode current collector)

The ratio A/B (μmol/m²) of the anion amount to the surface area of the positive electrode mixture layer is expressed by the following equation. That is, it is expressed as a division of the anion amount A (mmol) divided by the surface area B (m²) of the positive electrode mixture layer.

Ratio A/B of anion amount to surface area of positive electrode mixture layer=(anion amount A)/(surface area B of positive electrode mixture layer)×1000

When the electrode mixture layer is provided on both surfaces of the current collector, the surface area B of the positive electrode mixture layer is, as derived from the above definition, calculated by multiplying the total mass of the positive electrode mixture layers on both surfaces of the current collector by the surface area per unit mass of the positive electrode mixture layer (specific surface area b of positive electrode mixture layer).

The specific surface area b of the positive electrode mixture layer is a BET specific surface area determined using a measuring instrument conforming to JIS Z8830 (e.g., TriStar II 3020 available from Shimadzu Corporation). Specifically, the electrochemical capacitor is disassembled, from which the negative electrode is taken out. Then, the positive electrode mixture layer is peeled off from the positive electrode current collector, to collect about 0.5 g of a sample of the positive electrode mixture layer.

Next, the collected sample is heated at 150° C. for 12 hours in a reduced pressure of 95 kPa or less, and then, nitrogen gas is adsorbed onto the sample with a known mass, to obtain an adsorption isotherm in the relative pressure range of 0 to 1. Then, using a monomolecular layer adsorption amount of the gas obtained from the adsorption isotherm, the surface area of the sample is calculated. Here, a specific surface area b is calculated from the following BET equation by the BET single point method (relative pressure 0.3).

$$P / V ( P 0 - P ) = \{ ( 1 / ( Vm \cdot C ) ) \} + \{ ( C - 1 ) / ( Vm \cdot C ) \} ( P / P 0 ) \qquad ( 1 )$$

$$S = kVm \qquad ( 2 )$$

P0: saturated vapor pressure
P: adsorption equilibrium pressure
V: adsorption amount at adsorption equilibrium pressure P
Vm: monomolecular layer adsorption amount
C: parameter related to adsorption heat etc.
S: specific surface area b
k: area occupied by single molecule of nitrogen 0.162 nm²

The specific surface area of the positive electrode mixture layer generally reflects the specific surface area of the positive electrode active material. However, the specific surface area depends not only on the specific surface area of the positive electrode active material, but also on the specific surface area and the content amount of the materials other than the positive electrode active material, such as a conductive additive and a binder, that can be contained in the positive electrode mixture layer, and on how these materials are dispersed within the mixture layer.

The negative electrode active material preferably includes non-graphitizable carbon. Non-graphitizable carbon is sometimes called hard carbon. By using non-graphitizable carbon, excellent cycle characteristics can be obtained even under charge-discharge conditions in which rapid charging and rapid discharging are repeated. Also, an electrochemical capacitor can be realized which has high output and in which the internal resistance (DCR) is small even at low temperatures.

A surface layer portion is formed at the surface of the negative electrode mixture layer. The surface layer portion may have a first layer (lithium carbonate-containing layer) containing lithium carbonate. The first layer is mainly formed on the surface of the negative electrode active material. By forming the first layer containing lithium carbonate, the deterioration of the negative electrode can be significantly suppressed.

The surface layer portion formed at the negative electrode mixture layer may further have a second layer (solid electrolyte layer) including a solid electrolyte layer. The second layer can be formed so as to cover at least part of the surface of the first layer. The second layer has a composition different from that of the first layer, and the second layer is distinguishable from the first layer. In an electrochemical capacitor utilizing lithium ions, a solid electrolyte interface film (i.e., SEI film) is formed on the negative electrode mixture layer during charging and discharging. The second layer may be formed as an SEI film. The SEI film plays an important role in the charge-discharge reactions, but if the SEI film is formed too thick, the degradation of the negative electrode becomes severe. In contrast, the first layer containing lithium carbonate facilitates the formation of a good SEI film, and has an effect of maintaining the SEI film in good condition when charging and discharging are repeated. That is, when the first layer is present between the surface of the negative electrode active material and the second layer, to serve as a foundation layer for the second layer, the second layer is formed as a SEI film in good condition. Thus, when the surface layer portion has the first layer, it is possible to significantly suppress the degradation of the negative electrode even in the case of increasing the specific surface area of the negative electrode mixture layer in order to suppress the increase of the low temperature DCR.

The second layer also can contain lithium carbonate. When the second layer contains lithium carbonate, the content amount of the lithium carbonate in the second layer is smaller than the content amount of the lithium carbonate in the first layer. The presence of the first layer containing a large amount of lithium carbonate, as a foundation layer, is a necessary condition for the second layer to be formed as an SEI film in good condition.

The first layer is formed as at least part of the surface layer portion at the surface of the negative electrode mixture layer before assembling the electrochemical capacitor. In an electrochemical capacitor assembled using that negative electrode, a homogeneous second layer (SEI film) with an appropriate thickness is formed on the surface of the negative electrode active material by subsequent charging and discharging. The SEI film is formed, for example, through a reaction between the electrolyte and the negative electrode in the electrochemical capacitor. Since the electrolyte can pass through not only the second layer but also the first layer, the entire surface layer portion including the first layer and the second layer may be referred to as the SEI film, but in the present specification, for the sake of convenience, the second layer is referred to as the SEI film and is distinguished from the first layer.

The presence of a region like the first layer in which lithium carbonate is contained can be recognized, for example, by analyzing the surface layer portion by X-ray photoelectron spectroscopy (XPS). The analysis method, however, is not limited to XPS.

The first layer may have a thickness of, for example, 1 nm or more. The thickness may be set to 5 nm or more when expecting a longer-term effect, and may be set to 10 nm or more when expecting a more reliable effect. However, when the thickness of the first layer exceeds 50 nm, the first layer itself can become a resistance component. Therefore, the thickness of the first layer may be set to 50 nm or less, and may be set to 30 nm or less.

The second layer may have a thickness of, for example, 1 nm or more. The thickness may be 3 nm or more, and a thickness of 5 nm or more is sufficient. However, when the thickness of the second layer exceeds 20 nm, the second layer itself can become a resistance component. Therefore, the thickness of the second layer may be set to 20 nm or less, or may be set to 10 nm or less.

The ratio T1/T2 of the thickness T1 of the first layer to the thickness T2 of the second layer is preferably 1 or less from the viewpoint of reducing the initial low-temperature DCR. In this case, the thickness of the second layer is preferably 20 nm or less, and may be 10 nm or less. From the viewpoint of forming a second layer in good condition, it is desirable that the T1/T2 is 0.1 or more, and for example, the T1/T2 ratio may be 0.2 or more.

The thicknesses of the first layer and the second layer are measured by analyzing the surface layer portion formed at the surface of the negative electrode mixture layer, at a plurality of points (at least 5 points) of the negative electrode mixture layer. The average of the thicknesses of the first or second layer obtained at the plurality of points may be regarded as the thickness of the first or second layer. The negative electrode mixture layer to be used as a measurement sample may be peeled off from the negative electrode current collector. In this case, analysis may be performed on the surface film formed on the surface of the negative electrode active material constituting the vicinity of the surface layer portion of the negative electrode mixture layer. Specifically, the negative electrode active material covered with the surface film may be sampled from a region of the negative electrode mixture layer located on the surface side opposite to the surface joined to the negative electrode current collector, and used for analysis.

The XPS analysis on the surface layer portion of the negative electrode mixture layer is performed by, for example, within the chamber of an X-ray photoelectron spectrometer, irradiating an argon beam onto the surface layer portion or the surface film formed on the surface of the negative electrode active material, and observing and recording the changes in the respective spectra attributed to C1s electrons, O1s electrons, etc. versus the irradiation time. At this time, from the view point of avoiding analytical errors, the spectrum of the outermost surface of the surface layer portion may be ignored. The thickness of a region where a peak attributed to the lithium carbonate is stably observed corresponds to the thickness of the first layer.

In the negative electrode taken out from a completed electrochemical capacitor that has been subjected to a predetermined aging or at least one cycle of charging and discharging, the surface layer portion formed at the surface of the negative electrode mixture layer has an SEI film (i.e., a second layer) containing a solid electrolyte. The thickness of a region where a peak attributed to the bond that a compound contained in the SEI coating has is stably observed corresponds to the thickness of the SEI film (i.e., the thickness of the second layer).

As the compound contained in the SEI film, a compound containing an element that can be a label for the second layer is selected. The element that can be a label for the second layer may be, for example, an element (e.g., F) that is contained in the electrolyte and is not substantially contained in the first layer. As the compound containing an element that can be a label for the second layer, LiF can be selected, for example.

If the second layer contains LiF, a substantial peak of F1s attributed to the LiF bond is observed when the second layer is measured by X-ray photoelectron spectroscopy. In this case, the thickness of a region where a peak attributed to the LiF bond is stably observed corresponds to the thickness of the second layer.

On the other hand, the first layer is usually free of LiF, and even when the first layer is measured by X-ray photoelectron spectroscopy, no substantial peak of F1s attributed to the LiF bond is observed. Accordingly, the thickness of a region where a peak attributed to the LiF bond is not stably observed may be regarded as the thickness of the first layer.

In the SEI film, too, an O1s peak attributed to the lithium carbonate can be observed. However, the SEI film produced within the electrochemical capacitor has a different composition than that of the first layer formed in advance, and the two are distinguishable from each other. For example, in the XPS analysis of the SEI film, an F1s peak attributed to the LiF bond is observed, but no substantial peak of F1s attributed to the LiF bond is observed in the first layer. Also, the amount of lithium carbonate contained in the SEI film is very small. As the Li1s peak, for example, a peak derived from a compound, such as ROCOLi or ROLi, can be detected.

When the first layer is analyzed by XPS, a second peak of O1s attributed to the Li—O bond may be observed in addition to the first peak of O1s attributed to the C═O bond. A region of the surface film that is present near the surface of the negative electrode active material may contain a slight amount of LiOH or Li₂O.

Specifically, when the first layer included in the surface layer portion formed at the surface of the negative electrode mixture layer is analyzed in the depth direction, in the order of increasing distance from the outermost surface of the surface layer portion, a first region and a second region may be observed. The first region is a region in which a first peak (O1s attributed to the C═O bond) and a second peak (O1s attributed to the Li—O bond) are observed, and the first peak intensity is greater than the second peak intensity. The second region is a region in which the first peak and the second peak are observed and the second peak intensity is greater than the first peak intensity. In addition, a third region may be further present, which is closer to the outermost surface of the surface layer portion than the first region, and in which the first peak is observed but the second peak is not observed. The third region is likely to be observed when the thickness of the lithium carbonate-containing region is large. The relationship between the peak intensities can be determined by the heights of the peaks from the baseline.

In the center in the thickness direction of the first layer, usually, a C1s peak attributable to the C—C bond is not substantially observed, or even if observed, the peak intensity thereof is equal to or less than a half of the peak intensity attributable to the C═O bond.

Next, a method for forming a first layer containing lithium carbonate at the surface of the negative electrode mixture layer will be described. A step of forming the first layer may be performed by, for example, a gas phase method, a coating method, a transfer method, or the like.

As the gas phase method, chemical vapor deposition, physical vapor deposition, sputtering, and other methods can be used. For example, a vacuum vapor deposition apparatus may be used to attach lithium carbonate to the surface of the negative electrode mixture layer. The pressure in the chamber of the apparatus during vapor deposition is set to, for example, 10⁻² to 10⁻⁵ Pa, the temperature of a lithium carbonate evaporation source may be 400 to 600° C., and the temperature of the negative electrode mixture layer may be −20 to 80° C.

As the coating method, the first layer can be formed by applying a solution or liquid dispersion containing lithium carbonate onto a surface of the negative electrode using, for example, a micro gravure coater, followed by drying. The lithium carbonate is contained in the solution or liquid dispersion in an amount of, for example, 0.3 to 2 mass %, and when using a solution, may be contained at a concentration equal to or lower than the degree of solubility (e.g., about 0.9 to 1.3 mass % when using an aqueous solution at room temperature).

A negative electrode can be obtained by further performing a step of forming a second layer containing a solid electrolyte, so as to cover at least part of the first layer. In short, a surface layer portion can be formed at the surface of the negative electrode mixture layer. The obtained surface layer portion has the first layer and the second layer. The second layer is formed such that at least part thereof covers at least part of (preferably, all over) the surface of the negative electrode active material via the first layer (i.e., with the first layer as a foundation layer).

The step of forming a second layer, which is performed while the negative electrode mixture layer is in contact with the electrolyte, may also serve as at least part of a step of pre-doping lithium ions into the negative electrode mixture layer. As a lithium ion source to be pre-doped, metal lithium may be used, for example.

Metal lithium may be attached to the surface of the negative electrode mixture layer. A negative electrode having a negative electrode mixture layer to which metal lithium is attached may be exposed to a carbon dioxide atmosphere. This can form a first layer containing lithium carbonate and having a thickness of, for example, 1 nm or more and 50 nm or less.

The step of attaching metal lithium to the surface of the negative electrode mixture layer can be performed by, for example, a gas phase method, a transfer method, or the like. As the gas phase method, chemical vapor deposition, physical vapor deposition, sputtering, and other methods can be used. For example, a vacuum vapor deposition apparatus may be used to form metal lithium in the form of a film on the surface of the negative electrode mixture layer. The pressure in the chamber of the apparatus during vapor deposition is set to, for example, 10⁻² to 10⁻⁵ Pa, the temperature of a lithium evaporation source may be 400 to 600° C., and the temperature of the negative electrode mixture layer may be −20 to 80° C.

The carbon dioxide atmosphere is desirably a dry atmosphere that does not contain moisture, and it suffices when the dew point is, for example, −40° C. or less or −50° C. or less. The carbon dioxide atmosphere can contain a gas other than carbon dioxide, but the mole fraction of carbon dioxide is desirably 80% or more, more desirably 95% or more. It is desirable that no oxidizing gas is contained, and it suffices when the mole fraction of oxygen is 0.1% or less.

To form a thicker first layer, it is efficient to set the partial pressure of carbon dioxide to, for example, more than 0.5 atmospheric pressure (5.05×10⁴ Pa), and may be set to 1 atmospheric pressure (1.01×10⁵ Pa) or more.

The temperature of the negative electrode exposed to the carbon dioxide atmosphere may be, for example, in the range of 15° C. to 120° C. The higher the temperature is, the thicker the first layer is formed.

The thickness of the first layer can be easily controlled by changing the time for which the negative electrode is exposed to the carbon dioxide atmosphere. The exposure time may be, for example, 12 hours or more, and is less than 10 days.

It is desirable to perform the step of forming a first layer before constituting an electrode body, but this does not exclude the case of performing after constituting an electrode body. That is, the first layer may be formed at the surface of the negative electrode mixture layer by preparing a positive electrode, preparing a negative electrode having a negative electrode mixture layer with metal lithium attached thereto, forming an electrode body with a separator interposed between the positive electrode and the negative electrode, and exposing the electrode body to a carbon dioxide atmosphere.

The step of pre-doping lithium ions into the negative electrode mixture layer is completed by, for example, subsequently bringing the negative electrode mixture layer into contact with the electrolyte to allow pre-doping to further proceed, and leaving to stand for a predetermined time. Such a step can be a process of forming a second layer so as to cover at least part of the first layer. For example, by subjecting the electrochemical capacitor to at least one cycle of charging and discharging, it is possible to form a second layer in the negative electrode mixture layer, and also to complete the pre-doping of lithium ions into the negative electrode. Alternatively, the pre-doping of lithium ions into the negative electrode can be completed by, for example, applying a predetermined charging voltage (e.g., 3.4 to 4.0 V) between the terminals of the positive electrode and the negative electrode for a predetermined time (e.g., 1 to 75 hours).

The pre-doping of lithium ions into the negative electrode may be performed by bringing the negative electrode into contact with an electrolyte solution having lithium ion conductivity, before assembling an electrochemical capacitor. As a lithium ion source to be used for pre-doping, metal lithium may be used, for example. For example, pre-doping can be performed by placing a negative electrode and a working electrode (e.g., a metal plate made of SUS) to which a lithium ion source is attached, in an electrolytic cell filled with an electrolyte solution having lithium ion conductivity, with a separator interposed between the negative electrode and the working electrode, and applying a voltage between the positive electrode and the negative electrode, with the working electrode taken as the positive electrode (liquid-phase doping method). The voltage application can be performed, for example, under conditions in which a predetermined constant current flows between the positive electrode and the negative electrode. The voltage application time is, for example, 1 to 75 hours.

The metal lithium as a lithium ion source may be attached in advance to the surface of the negative electrode mixture layer. In this case, pre-doping may be performed by placing a negative electrode to which the metal lithium is attached, in an electrolytic cell, and applying a voltage between the negative electrode and the working electrode (solid-phase doping method).

In the liquid-phase doping method, when the concentration of the lithium salt in the electrolyte solution is lowered, the ion conductivity of the electrolyte solution decreases, which necessitates a long time for the pre-doping process. On the other hand, in the solid-phase doping method, in which the metal lithium is attached to the surface of the negative electrode mixture layer in advance, the concentration of the lithium salt in the electrolyte solution has little effect on the processing time required for the pre-doping process.

In the process of forming a second layer (SEI film) in the electrochemical capacitor, the amount of lithium salt required to react with the negative electrode mixture layer may be small when the solid-phase doping method is used to form the first layer, as compared to when the liquid-phase doping method is used. This is presumably because the first layer formed by the solid-phase doping method can cover the entire surface of the negative electrode mixture layer, which is advantageous in ensuring a sufficient thickness of the surface film. Thus, the electrolyte solution amount and the concentration of the electrolyte in the electrochemical capacitor are unlikely to increase excessively, and an electrochemical capacitor having low internal resistance and high output is likely to be obtained.

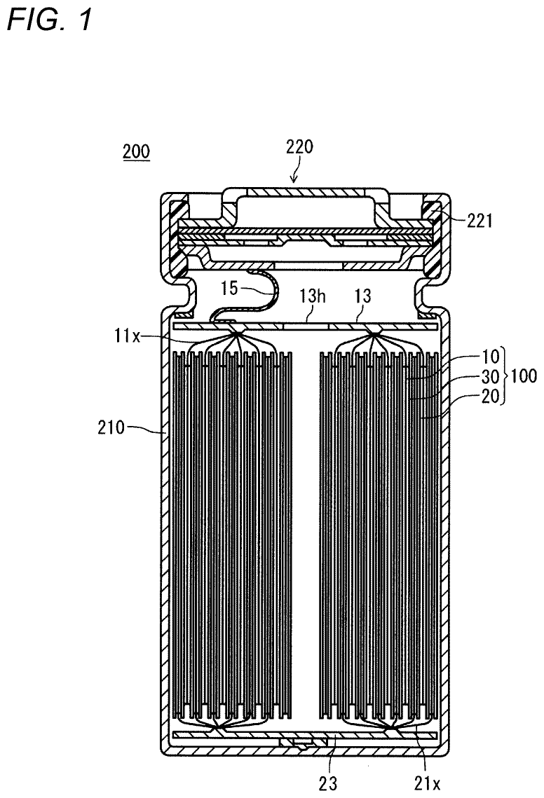

FIG. 1 schematically illustrates a configuration of an electrochemical capacitor 200 according to one embodiment of the present invention. The electrochemical capacitor 200 includes an electrode body 100, a nonaqueous electrolyte solution (not shown), a bottomed metal cell case 210 housing the electrode body 100 and the nonaqueous electrolyte solution, and a sealing plate 220 sealing the opening of the cell case 210. A gasket 221 is disposed at the periphery of the sealing plate 220, and the inside of the cell case 210 is sealed by crimping the open end of the cell case 210 onto the gasket 221. A positive electrode current collecting plate 13 having a through-hole 13h at its center is welded to a positive electrode current collector-exposed portion 11x. The other end of the tab lead 15, one end of which is connected to the positive electrode current collecting plate 13, is connected to the inner surface of the sealing plate 220. Thus, the sealing plate 220 functions as an external positive electrode terminal. On the other hand, a negative electrode current collecting plate 23 is welded to a negative electrode current collector-exposed portion 21x. The negative electrode current collecting plate 23 is directly welded to a welding member provided on the inner bottom surface of the cell case 210. Thus, the cell case 210 functions as an external negative electrode terminal.

Each component of the electrochemical capacitor according to an embodiment of the present invention will be described below in more detail.

### (Negative Electrode)

The negative electrode includes a negative electrode current collector, and a negative electrode mixture layer supported on the negative electrode current collector. The negative electrode mixture layer contains a negative electrode active material into which lithium ions are reversibly doped. The negative electrode active material preferably includes non-graphitizable carbon (i.e., hard carbon). The thickness of the negative electrode mixture layer is, for example, 10 to 300 μm per one surface of the negative electrode current collector.

For the negative electrode current collector, a sheet-shaped metal material is used. The sheet-shaped metal material may be a metal foil, a metal porous body, an etched metal, and the like. As the metal material, copper, copper alloy, nickel, stainless steel, and the like can be used.

The negative electrode current collecting plate is an approximately disc-shaped metal plate. Examples of the material of the negative electrode current collecting plate include copper, copper alloy, nickel, and stainless steel. The material of the negative electrode current collecting plate may be the same as that of the negative electrode current collector.

The non-graphitizable carbon may have an interplanar spacing d002 of the (002) plane (i.e., an interplanar spacing between carbon layers) measured by X-ray diffractometry of 3.8 Å or more. The theoretical capacity of the non-graphitizable carbon is desirably, for example, 150 mAh/g or more. By using non-graphitizable carbon, a negative electrode in which the low-temperature DCR is small, and expansion and contraction during charging and discharging are small is likely to be obtained. The non-graphitizable carbon desirably accounts for 50 mass % or more, further 80 mass % or more, and further 95 mass % or more of the negative electrode active material. The non-graphitizable carbon desirably accounts for 40 mass % or more, further 70 mass % or more, and further 90 mass % or more of the negative electrode mixture layer.

As the negative electrode active material, non-graphitizable carbon and a material other than non-graphitizable carbon may be used in combination. Examples of the material other than non-graphitizable carbon that can be used as the negative electrode active material include graphitizable carbon (soft carbon), graphite (natural graphite, artificial graphite, etc.), lithium titanium oxide (spinel-type lithium titanium oxide, etc.), silicon oxide, silicon alloy, tin oxide, and tin alloy.

From the viewpoint of high packability of the negative electrode active material in the negative electrode and suppression of side reactions with the electrolyte, the average particle diameter of the negative electrode active material (esp., non-graphitizable carbon) is preferably 1 μm to 20 μm, more preferably 2 μm to 15 μm.

In the present specification, the average particle diameter means a volume-based median diameter (D50) in a particle size distribution obtained by laser diffraction particle size distribution measurement.

The negative electrode mixture layer contains a negative electrode active material as an essential component, and contains, as optional components, a conductive agent (conductive assistant), a binder, and the like. Examples of the conductive agent include carbon black, and carbon fibers. Examples of the binder include fluorocarbon resins, acrylic resins, rubber materials, and cellulose derivatives.

The negative electrode mixture layer is formed by, for example, mixing a negative electrode active material, and a conductive agent, a binder, etc., together with a dispersion medium, to prepare a negative electrode mixture slurry, and applying the negative electrode mixture slurry to a negative electrode current collector, followed by drying.

The negative electrode mixture layer is pre-doped with lithium ions in advance. This lowers the potential of the negative electrode, which increases the potential difference (i.e., voltage) between the positive electrode and the negative electrode, leading to improved energy density of the electrochemical capacitor. The amount of lithium to be pre-doped may be about 50% to 95% of the maximum amount that can be absorbed into the negative electrode mixture layer.

The potential of the negative electrode is, for example, 0.2 V or less based on lithium. The above potential of the negative electrode corresponds to the negative electrode potential (25° C.) upon completion of pre-doping of lithium ions (or during charging). The first and second regions of the negative electrode (negative electrode mixture layer) are pre-doped with lithium ions in advance. This lowers the potential of the negative electrode, which increases the potential difference (i.e., voltage) between the positive electrode and the negative electrode, leading to improved energy density of the electrochemical capacitor. The amount of lithium to be pre-doped is set such that the potential of the negative electrode in the electrolyte solution upon completion of pre-doping of lithium ions (or during charging) is, for example, 0.2 V or less relative to metal lithium.

The capacitance per unit mass of the negative electrode active material may be, for example, 1,000 F/g or more. From the viewpoint of increasing the capacity density of the electrochemical capacitor, the capacitance per unit mass of the negative electrode active material may be, for example, 30,000 F/g or less. The capacitance per unit mass of the negative electrode active material is usually larger than the capacitance per unit mass of the positive electrode active material, and is, for example, 20 to 800 times as large as the capacitance per unit mass of the positive electrode active material. The capacitance per unit mass of the negative electrode active material can be measured in the following manner.

First, a negative electrode for evaluation cut out in a size of 31 mm×41 mm is prepared. As a counter electrode for the negative electrode, a 100-μm-thick lithium metal foil cut out in a size of 40 mm×50 mm is prepared. With a 25-μm-thick cellulose paper (e.g., product number TF4425) available from Nippon Kodoshi Corporation interposed therebetween as a separator, the negative electrode mixture layer and the lithium metal foil are placed so as to face each other, into an electrode body, and the electrode body is immersed in a below-described electrolyte solution of Example 1, to fabricate a cell.

Charging is performed at a constant current (CC) of 0.5 mA until the cell voltage reaches 0.01 V, followed by charging at a constant voltage (CV) for 1 hour. Subsequently, discharging is performed at 0.5 mA until the cell voltage reaches 1.5 V. The capacitance per unit mass of the negative electrode active material is calculated from the discharge time during which the potential of the negative electrode changes by 0.1 V from 1 minute after the start of discharging.

### (Positive Electrode)

The positive electrode includes a positive electrode current collector, and a positive electrode mixture layer containing activated carbon, and supported on the positive electrode current collector. The positive electrode mixture layer contains a positive electrode active material into which anions are reversibly doped, and the positive electrode active material contains activated carbon. The thickness of the positive electrode mixture layer is, for example, 10 to 300 μm per one surface of the positive electrode current collector.

For the positive electrode current collector, a sheet-shaped metal material is used. The sheet-shaped metal material may be a metal foil, a metal porous body, an etched metal, or the like. As the metal material may be aluminum, aluminum alloy, nickel, titanium, and the like can be used.

The positive electrode current collecting plate is an approximately disc-shaped metal plate. Preferably, the positive electrode current collecting plate is provided at its center portion with a through-hole serving as a passage for the nonaqueous electrolyte solution. Examples of the material of the positive electrode current collecting plate includes aluminum, aluminum alloy, titanium, and stainless steel. The material of the positive electrode current collecting plate may be the same as that of the positive electrode current collector.

As the carbon material used as the positive electrode active material, a porous carbon material is preferred, and, for example, activated carbon, and a carbon material exemplified as the negative electrode active material (e.g., non-graphitizable carbon) are preferred. Examples of the raw material of the activated carbon include wood, palm shells, coal, pitch, and phenolic resin. The activated carbon is preferably one subjected to activation treatment.

The average particle diameter of the activated carbon is, although not limited to, preferably 20 μm or less, more preferably 3 μm to 15 μm.

The specific surface area of the positive electrode mixture layer generally reflects the specific surface area of the positive electrode active material. The specific surface area of the positive electrode mixture layer may be, for example, 1000 m²/g or more and 2000 m²/g or less, and is desirably 1200 m²/g or more and 1800 m²/g or less. The specific surface area of the positive electrode mixture layer is a BET specific surface area obtained using a measuring instrument conforming to JIS Z8830 (e.g., TriStar II 3020 available from Shimadzu Corporation). Specifically, the electrochemical capacitor is disassembled, from which the positive electrode is taken out. Next, the positive electrode is washed with DMC, and dried. Then, the positive electrode mixture layer is peeled off from the positive electrode current collector, to collect about 0.5 g of a sample of the positive electrode mixture layer. Next, the specific surface area of the collected sample is measured according to the already-described method for measuring the specific surface area of the negative electrode mixture layer.

It is desirable that the activated carbon accounts for 50 mass % or more, further 80 mass % or more, and further 95 mass % or more of the positive electrode active material. It is desirable that the activated carbon accounts for 40 mass % or more, further 70 mass % or more, and further 90 mass % or more of the positive electrode mixture layer.

The positive electrode mixture layer contains a positive electrode active material as an essential component, and contains, as optional components, a conductive agent, a binder, a thickener, and the like. Examples of the conductive agent include carbon black, and carbon fibers. Examples of the binder include fluorocarbon resins, acrylic resins, rubber materials, and cellulose derivatives.

The positive electrode mixture layer is formed by, for example, mixing a positive electrode active material, and a conductive agent, a binder, etc., together with a dispersion medium, to prepare a positive electrode mixture slurry, and applying the positive electrode mixture slurry to a negative electrode current collector, followed by drying.

### (Separator)

As the separator, a non-woven fabric made of cellulose fibers, a non-woven fabric made of glass fibers, a microporous film or a woven or non-woven fabric made of polyolefin, and like can be used. The thickness of the separator is, for example, 8 to 300 μm, and preferably 8 to 40 μm.

### (Electrolyte Solution)

The electrolyte solution has lithium ion conductivity, and contains, for example, a lithium salt and a solvent that dissolves the lithium salt. The lithium salt dissolved in the solvent contains lithium ions and anions. The anions of the lithium salt are reversibly doped into and de-doped from the positive electrode repeatedly. The lithium ions derived from the lithium salt are reversibly absorbed into and released from the negative electrode.

Examples of the lithium salt include LiClO₄, LiBF₄, LiPF₆, LiAlCl₄, LiSbF₆, LiSCN, LiCF₃SO₃, LiFSO₃, LiCF₃CO₂, LiAsF₆, LiB₁₀Cl₁₀, LiCl, LiBr, LiI, LiBCl₄, LiN(FSO₂)₂, and LiN(CF₃SO₂)₂. These may be used singly or in combination of two or more kinds. In particular, a salt having a fluorine-containing anion is preferred, and especially, lithium bis(fluorosulfonyl)imide, that is, LiN(SO₂F)₂, is preferably used. The concentration of the lithium salt in the electrolyte solution in a charged state (state of charge (SOC) 90 to 100%) is, for example, 0.2 to 5 mol/L. Hereinafter, LiN(SO₂F)₂ is referred to as LiFSI. For example, 80 mass % or more of the lithium salt may be LiFSI.

When LiFSI is used, the increase rate of the low-temperature DCR shows a tendency to significantly decrease. LiFSI is considered to have an effect of reducing the degradation of the positive electrode active material and the negative electrode active material. Among the salts having a fluorine-containing anion, FSI anions, which have excellent stability, are considered to hardly produce byproducts and smoothly contribute to charging and discharging without damaging the surface of the active material. Especially in the case of increasing the capacity of the positive electrode, and increasing the specific surface area of the negative electrode mixture layer, the effect of suppressing the deterioration (the effect of suppressing the increase in low-temperature DCR) produced by using LiFSI, which significantly reduces the influence of by-products on each active material, can be remarkably obtained.

Examples of the solvent that can be used include: cyclic carbonates, such as ethylene carbonate, propylene carbonate, and butylene carbonate; chain carbonates, such as dimethyl carbonate, diethyl carbonate, and ethyl methyl carbonate; aliphatic carboxylic acid esters, such as methyl formate, methyl acetate, methyl propionate, and ethyl propionate; lactones, such as γ-butyrolactone (GBL), and γ-valerolactone; chain ethers, such as 1,2-dimethoxyethane (DME), 1,2-diethoxyethane (DEE), and ethoxymethoxyethane (EME); cyclic ethers, such as tetrahydrofuran and 2-methyltetrahydrofuran; and others, such as dimethyl sulfoxide, 1,3-dioxolane, formamide, acetamide, dimethylformamide, dioxolane, acetonitrile, propionitrile, nitromethane, ethyl monoglyme, trimethoxymethane, sulfolane, methylsulfolane, and 1,3-propane sultone. These may be used singly or in combination of two or more kinds.

Various additives may be added, as necessary, to the electrolyte solution. For example, as an additive for forming a surface layer with lithium ion conductivity on a surface of the negative electrode, an unsaturated carbonate, such as vinylene carbonate, vinyl ethylene carbonate, and divinyl ethylene carbonate, may be added.

### (Supplementary Notes)

The above description discloses the following techniques.

### (Technique 1)

An electrochemical capacitor, comprising:
a positive electrode including a positive electrode current collector, and a positive electrode mixture layer containing activated carbon, and supported on the positive electrode current collector;
a negative electrode including a negative electrode current collector, and a negative electrode mixture layer containing a negative electrode active material into which lithium ions are reversibly doped, and supported on the negative electrode current collector; and
an electrolyte solution including an electrolyte containing lithium ions and anions, and a nonaqueous solvent, wherein
a ratio of an amount of the anions to a surface area of the positive electrode mixture layer is 1.5 μmol/m² or more and 2.4 μmol/m² or less.

### (Technique 2)

The electrochemical capacitor according to technique 1, wherein the ratio of the amount of the anions to the surface area of the positive electrode mixture layer is 1.7 μmol/m² or more and 2.2 μmol/m² or less.

### (Technique 3)

The electrochemical capacitor according to technique 1 or 2, wherein the electrolyte solution includes lithium bis(fluorosulfonyl)imide.

### (Technique 4)

The electrochemical capacitor according to any one of techniques 1 to 3, wherein the negative electrode active material includes non-graphitizable carbon.

### (Technique 5)

The electrochemical capacitor according to any one of techniques 1 to 4, wherein a potential of the negative electrode is 0.2 V or less based on lithium.

### (Technique 6)

The electrochemical capacitor according to technique 1, wherein at a surface of the negative electrode mixture layer, a surface layer portion having a first layer containing lithium carbonate is formed.

### (Technique 7)

The electrochemical capacitor according to technique 6, wherein
the surface layer portion formed at the surface of the negative electrode mixture layer has a second layer containing a solid electrolyte, and
at least part of the second layer covers at least part of the surface of the negative electrode mixture layer via the first layer.

### (Technique 8)

The electrochemical capacitor according to technique 7, wherein
the second layer contains lithium carbonate, and
a content amount of the lithium carbonate in the second layer is smaller than a content amount of the lithium carbonate in the first layer.

### (Technique 9)

The electrochemical capacitor according to any one of techniques 6 to 8, wherein the first layer has a thickness of 1 nm or more and 50 nm or less.

### (Technique 10)

The electrochemical capacitor according to technique 7 or 8, wherein
when the first layer is measured by X-ray photoelectron spectroscopy, no substantial peak of F1s attributed to a LiF bond is observed, and
when the second layer is measured by X-ray photoelectron spectroscopy, a substantial peak of F1s attributed to a LiF bond is observed.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

### EXAMPLES

The present invention will be described in more detail below, with reference to Examples. The present invention, however, is not limited to the Examples. The configurations of respective electrochemical capacitors fabricated below are summarized in Table 1.

### (Electrochemical Capacitors A1 to A5, B1 and B2)

### (1) Production of Positive Electrode

A 20-μm-thick aluminum foil (positive electrode current collector) was prepared. On the other hand, 88 parts by mass of activated carbon (average particle diameter 5.5 μm) serving as a positive electrode active material, 2 parts by mass of polytetrafluoroethylene (PTFE) serving as a binder, 4 parts by mass of carboxymethyl cellulose (CMC) serving as a thickener, and 6 parts by mass of acetylene black (AB) serving as a conductive agent were dispersed in water, to prepare a positive electrode mixture slurry. The obtained positive electrode mixture slurry was applied onto both surfaces of the aluminum foil, and the applied films were dried and rolled, into positive electrode mixture layers, to obtain a positive electrode. At the end of the positive electrode current collector along the longitudinal direction, A positive electrode current collector-exposed portion having a width of 10 mm was formed. The weight of the positive electrode mixture layer included per one cell of the electrochemical capacitor in the obtained positive electrode was 2.3 g. The specific surface area b of the positive electrode mixture layer was 1407 m²/g, and the surface area B of the positive electrode mixture layer was 3285 m² per cell of the electrochemical capacitor.

### (2) Production of Negative Electrode

An 8-μm-thick copper foil (negative electrode current collector) was prepared. On the other hand, non-graphitizable carbon (HC) (average particle diameter 5 μm) serving as a negative electrode active material, carboxymethyl cellulose (CMC), and styrene butadiene rubber (SBR) were dispersed in water, to prepare a negative electrode mixture slurry. The obtained negative electrode mixture slurry was applied onto both surfaces of the copper foil, the applied films were dried and rolled into negative electrode mixture layers, to obtain a negative electrode.

Subsequently, a thin film of metal lithium for pre-doping was formed by vacuum vapor deposition on the entire surface of the negative electrode mixture layers. The amount of lithium to be pre-doped was set such that the potential of the negative electrode in the nonaqueous electrolyte solution upon completion of pre-doping was 0.2 V or less relative to metal lithium.

Subsequently, the chamber of the apparatus was purged with carbon dioxide to be a carbon dioxide atmosphere, to form a first layer containing lithium carbonate, at the surface of the negative electrode mixture layer. The dew point of the carbon dioxide atmosphere was set to −40° C., the mole fraction of carbon dioxide was set to 100%, and the pressure in the chamber was set to 1 atmospheric pressure (1.01×10⁵ Pa). The temperature of the negative electrode exposed to the carbon dioxide atmosphere at 1 atmospheric pressure was set to 25° C. The time for exposing the negative electrode to the carbon dioxide atmosphere was set to 22 hours. The first layer was substantially free of F (or LiF).

The mixing ratio of non-graphitizable carbon (HC), carboxymethyl cellulose (CMC), and styrene butadiene rubber (SBR) in the negative electrode mixture slurry was set to HC:CMC:SBR=97:1:2 by mass.

### (3) Production of Electrode Body

The positive electrode and the negative electrode were wound in a columnar shape, with a nonwoven-fabric separator (thickness 25 μm) made of cellulose interposed therebetween, to form an electrode body. At this time, the positive electrode current collector-exposed portion was protruded from one end face of the wound body, and the negative electrode current collector-exposed portion was protruded from the other end face of the electrode body. A disc-shaped positive electrode current collecting plate and a disc-shaped negative electrode current collecting plate were respectively welded to the positive electrode current collector-exposed portion and the negative electrode current collector-exposed portion.

### (4) Preparation of Nonaqueous Electrolyte Solution

Ethylene carbonate (EC), ethyl methyl carbonate (EMC), and diethyl carbonate (DEC) were mixed in a volume ratio of 3:5:2, to which 0.2 mass % of vinylene carbonate (VC) was further added, to prepare a solvent. LiFSI was dissolved as a lithium salt in the obtained solvent at a molar concentration as shown in Table 1, to prepare a nonaqueous electrolyte solution.

### (5) Fabrication of Electrochemical Capacitor

The electrode body was housed in a bottomed cell case having an opening, and a tab lead connected to the positive electrode current collecting plate was connected to the inner surface of a sealing plate, and the negative electrode current collecting plate was welded to the inner bottom surface of the cell case. After the nonaqueous electrolyte solution was injected into the cell case in an amount as shown in Table 1, the opening of the cell case was closed with the sealing plate. Thus, an electrochemical capacitor as shown in FIG. 1 was fabricated.

TABLE 1

| | electrolyte solution | | | |
|---|---|---|---|---|
| | molar | | specific | anion |
| electrochemical | concentration | mass | gravity | amount A |
| capacitor | M | g | g/cm³ | mmol |
| B1 | 0.6 | 8.9 | 1.15 | 4.6 |
| A1 | 0.65 | 8.8 | 1.155 | 5.0 |
| A2 | 0.73 | 8.9 | 1.163 | 5.6 |
| A3 | 0.86 | 9 | 1.176 | 6.6 |
| A4 | 0.95 | 9.1 | 1.185 | 7.3 |
| A5 | 1.04 | 9.1 | 1.194 | 7.9 |
| B2 | 1.07 | 9.2 | 1.197 | 8.2 |

Thereafter, aging was performed at 60° C. with a charge voltage of 3.8 V applied between the terminals of the positive electrode and the negative electrode, to complete pre-doping of lithium ions into the negative electrode.

In this way, a plurality of electrochemical capacitors A1 to A5, B1 and B2 were produced, with varying the molar concentration of the electrolyte contained in the electrolyte solution and the mass of the electrolyte solution, and subject to the following evaluation.

### (6) Evaluation

### (Measurement of Internal Resistance of Electrochemical Capacitor)

With respect to the electrochemical capacitor immediately after aging, in a −30° C. environment, a constant-current charging was performed at a current density of 2 mA/cm² per positive electrode area until the voltage reached 3.8 V, followed by holding for 10 minutes with the voltage of 3.8 V applied thereto. Then, in a −30° C. environment, a constant-current discharging was performed at a current density of 2 mA/cm² per positive electrode area until the voltage reached 2.2 V.

Using the discharge curve (vertical axis: discharge voltage, horizontal axis: discharge time) obtained from the above discharging, a linear approximation line was obtained in the range of 0.5 seconds to 2 seconds after the start of discharging in the discharge curve, and a voltage VS at the intercept with the approximation line was obtained. The value (V0-VS) obtained by subtracting the voltage VS from a voltage V0 at the start of discharging (0 seconds after the start of discharging) was calculated as ΔV. Using the ΔV (V) and a current value (current density 2 mA/cm² per positive electrode area×positive electrode area) during discharging, an internal resistance (DCR) R1 (mΩ) of the electrochemical capacitor was calculated from the following equation.

$$Internal resistance R 1 = Δ V / Id$$

### (Float Test of Electrochemical Capacitor)

Next, in an 85° C. environment, a float test was performed in which the electrochemical capacitor was held for 1000 hours with a constant voltage of 3.8 V applied thereto. Thereafter, in a −30° C. environment, an internal resistance (DCR) R2 (mΩ) of the electrochemical capacitor was determined in the same manner as the R1.

The capacity C2 and the internal resistance R2 after the float test in the electrochemical capacitors A1 to A5, B1 and B2 are shown in Table 2. In Table 2, the C2 and the R2 are shown as relative values, with the capacity C2 and the R2 after the float test in the electrochemical capacitor A3 taken as 100, respectively. The electrochemical capacitors A1 to A5 are of Examples, and the B1 and B2 are of Comparative Examples.

In Table 2, the aforementioned ratio A/B of the anion amount to the surface area of the positive electrode mixture layer is shown, together with the evaluation results after the float test.

Table 2 shows that in the electrochemical capacitors A1 to A5 in which the A/B was in the range of 1.5 to 2.4 μmol/m², the internal resistance R2 after the float test was low, and furthermore, in the electrochemical capacitors A2 to A4 in which A/B in the range of 1.7 to 2.2 μmol/m², the internal resistance R2 after the float test was significantly low, and excellent output characteristics were obtained.

On the other hand, in the electrochemical capacitor B1 in which the A/B was small, not only sufficient capacity failed to be exhibited, but also the internal resistance R2 after the float test was increased. This was presumably because the anion amount A to be reversibly doped was insufficient relative to the surface of the positive electrode mixture layer. Furthermore, in the electrochemical capacitor B2 in which the A/B was large, although sufficient capacity was exhibited, the internal resistance R2 after the float test was increased.

The comparison among the electrochemical capacitors A1 to A5, B1, and B2 showed that the internal resistance R2 after the float test was the lowest in the electrochemical capacitor A3 in which the A/B was 2.0 μmol/m², indicating that when the A/B was in the range of 1.5 to 2.4 μmol/m², the internal resistance R2 after the float test was maintained at a sufficiently low value.

TABLE 2

| | ratio A/B of anion amount | float test | |
|---|---|---|---|
| | to surface area of | | internal |
| electrochemical | positive electrode material | capacity | resistance |
| capacitor | mixture μmol/m² | C2 | R2 |
| B1 | 1.4 | 91 | 106 |
| A1 | 1.5 | 96 | 103 |
| A2 | 1.7 | 99 | 101 |
| A3 | 2.0 | 100 | 100 |
| A4 | 2.2 | 101 | 102 |
| A5 | 2.4 | 101 | 105 |
| B2 | 2.5 | 101 | 110 |

### INDUSTRIAL APPLICABILITY

The electrochemical capacitor according to the present invention is suitably applicable to, for example, in-vehicle use.

### REFERENCE SIGNS LIST

100: Electrode body
   10: positive electrode
   11x: positive electrode current collector-exposed portion
   13: positive electrode current collecting plate
   15: tab lead
   20: negative electrode
   21x: negative electrode current collector-exposed portion
   23: negative electrode current collecting plate
   30: separator
200: electrochemical capacitor
   210: cell case
   220: sealing plate
   221: gasket

1. An electrochemical capacitor, comprising:
a positive electrode including a positive electrode current collector, and a positive electrode mixture layer containing activated carbon, and supported on the positive electrode current collector;
a negative electrode including a negative electrode current collector, and a negative electrode mixture layer containing a negative electrode active material into which lithium ions are reversibly doped, and supported on the negative electrode current collector; and
an electrolyte solution including an electrolyte containing lithium ions and anions, and a nonaqueous solvent, wherein
a ratio of an amount of the anions to a surface area of the positive electrode mixture layer is 1.5 μmol/m² or more and 2.4 μmol/m² or less.

2. The electrochemical capacitor according to claim 1, wherein the ratio of the amount of the anions to the surface area of the positive electrode mixture layer is 1.7 μmol/m² or more and 2.2 μmol/m² or less.

3. The electrochemical capacitor according to claim 1, wherein the electrolyte solution includes lithium bis(fluorosulfonyl)imide.

4. The electrochemical capacitor according to claim 1, wherein the negative electrode active material includes non-graphitizable carbon.

5. The electrochemical capacitor according to claim 1, wherein a potential of the negative electrode is 0.2 V or less based on lithium.

6. The electrochemical capacitor according to claim 1, wherein at a surface of the negative electrode mixture layer, a surface layer portion having a first layer containing lithium carbonate is formed.

7. The electrochemical capacitor according to claim 6, wherein
the surface layer portion formed at the surface of the negative electrode mixture layer has a second layer containing a solid electrolyte, and
at least part of the second layer covers at least part of the surface of the negative electrode mixture layer via the first layer.

8. The electrochemical capacitor according to claim 7, wherein
the second layer contains lithium carbonate, and
a content amount of the lithium carbonate in the second layer is smaller than a content amount of the lithium carbonate in the first layer.

9. The electrochemical capacitor according to claim 6, wherein the first layer has a thickness of 1 nm or more and 50 nm or less.

10. The electrochemical capacitor according to claim 7, wherein
when the first layer is measured by X-ray photoelectron spectroscopy, no substantial peak of F1s attributed to a LiF bond is observed, and
when the second layer is measured by X-ray photoelectron spectroscopy, a substantial peak of F1s attributed to a LiF bond is observed.
